(19) United States
(12) Patent Application Publication
(10) Pub. No.: US 2024/0382816 A1
(43) Pub. Date: Nov. 21, 2024

(54) RECYCLABLE REMOVABLE CLIMBING GRIP FOR AN ARTIFICIAL CLIMBING STRUCTURE AND ARTIFICIAL STRUCTURE COMPRISING SAID GRIP

(71) Applicant: SBH EQUIPEMENTS, Le Bourget du Lac (FR)

(72) Inventors: Sébastien Leprivey, Val-d'Isère (FR); Benoît Jacquot-Bertrand, Chambéry (FR); Hugo Pheulpin, Chambéry (FR)

(73) Assignee: SBH EQUIPEMENTS, Le Bourget du Lac (FR)

(21) Appl. No.: 18/693,928

(22) PCT Filed: Sep. 29, 2022
(86) PCT No.: PCT/EP2022/077215

§ 371 Date: Mar. 20, 2024

(30) Foreign Application Priority Data
Sep. 30, 2021 (FR) FR2110312

(51) Int. Cl. A63B 69/00

(52) U.S. Cl. CPC A63B 69/0048; A63B 2209/00

(57) ABSTRACT

Recyclable climbing grip (3) for an artificial climbing structure characterized in that it comprises a body (4) made of a composition comprising at least one thermoplastic material.

The invention concerns a removable climbing hold for an artificial climbing structure. The invention also concerns an artificial climbing structure including said climbing hold. The invention finally relates to a method of manufacturing said climbing hold.

Artificial climbing structures, also known as climbing “walls”, conventionally consist of a wall on which are fixed removable artificial holds so as to form routes of varying difficulty enabling users to move along the structure.

The artificial holds are conventionally obtained by molding thermoset materials, in particular resin or resin concrete, thereby rendering them non-recyclable.

Furthermore, mechanical and/or chemical treatments, such as flaming, sandblasting or chemical attack are combined with the application of one or more coating layers, for example a resin coating covered with sand and/or silica, on at least one exterior surface of such holds, which come into contact with limbs of the users, in order to generate a rough surface having an adhesion suitable for climbing. Such resins also have the disadvantage of not being recyclable.

One of the major constraints in the manufacture of climbing holds lies in the safety of the climbers. In fact, it is essential to limit the risks of a climbing hold breaking because it is worn, because of its use or because of impacts it has received, for example because of a fall or because of handling it. In this regard it is known to produce climbing holds having a more rigid and stronger solid body. The weight of such holds nevertheless increases the hazards in the event of them breaking. Moreover, because of their weight, handling and installing such holds in an artificial structure is made more complicated.

The invention is inscribed within this context and aims to propose removable holds for an artificial climbing structure that are made from at least one thermoplastic material so as to be recyclable but that are also robust so as to be suitable for repeated stress. The invention further aims to propose lighter alternatives to existing climbing holds. The invention moreover aims to propose a method of manufacturing such holds advantageously enabling subsequent surface treatments to be dispensed with.

The invention concerns a removable climbing hold for an artificial climbing structure characterized in that it comprises a body made of a composition including at least one thermoplastic material. In particular, the composition may include at least 50% of at least one thermoplastic material or of a mixture of thermoplastic materials.

In accordance with one embodiment most of the body, that is to say at least 50% of the body, may have a thickness greater than or equal to 8 mm, in particular greater than or equal to 10 mm.

In accordance with another embodiment the body may have a solid monobloc shape in which most of the body, that is to say at least 50% of the body, has a thickness greater than or equal to 5 mm, in particular greater than or equal to 8 mm, or even 10 mm. In particular, the hold may include at least one through-opening extending through the body and configured to receive at least one means for fixing the hold.

In accordance with another embodiment the body may have a hollow monobloc shape. Such a hold may in particular include at least one through-opening extending through the body and configured to receive at least one means for fixing the hold.

Independently of the embodiment employed, all or part of a first surface of the body, configured to be in contact with a limb of a user, may include at least one grained zone, said at least one grained zone being essentially, that is to say over at least 50% of its surface, made of the at least one thermoplastic material.

In particular, for the composition of the body of the hold, the at least one thermoplastic material may be selected from thermoplastic polyurethanes, copolyester thermoplastic elastomers, polyamide thermoplastic elastomers, styrene-based thermoplastic elastomers, thermoplastic polyolefins, polyacrylics, polycarbonates, polyphenylene sulfide and/or polymethacrylates.

Furthermore, the composition of the body may include at least one charge, in particular a recyclable charge, and/or at least one adjuvant selected from a coloring agent or pigment, a plasticizing agent, a swelling agent and/or an anti-UV agent. In particular the composition may consist of at least 50% of at least one thermoplastic material or of a mixture of thermoplastic materials, 0 to 15%, or even 1 to 10%, of the at least one adjuvant, and/or 0 to 30%, or even 1 to 20%, of the at least one charge.

The at least one adjuvant may in particular be a swelling agent, selected from citric acid, sodium bicarbonate, azodicarbonamides (ADC), oxy-bis benzenesulfonyl hydrazides (OBSH), toluenesulfonylhydrazide (TSH), water and/or plastic microspheres containing a gas, in particular carbon dioxide, isobutane, isooctane, isopentane and/or pentane.

The at least one charge may be selected from calcium carbonate, talc, mica, glass, a natural mineral charge and/or a natural vegetable charge.

The invention also concerns an artificial climbing structure comprising at least one wall and at least one climbing hold according to the invention mounted on and fixed to said wall.

The present invention finally proposes a method of manufacturing a climbing hold as described above for an artificial climbing structure, the method including a step of injection, intrusion and/or coextrusion of the composition including at least one thermoplastic material at low pressure, in particular at a pressure between 0 and 200 bar inclusive, or even between 0 and 75 bar inclusive or between 0 and 50 bar inclusive, into a flexible mold, in particular a mold made of an elastomer material or of rubber.

Other details, features and advantages will emerge more clearly on reading the detailed description given hereinafter by way of non-limiting illustration with reference to the various embodiments depicted in the following figures:

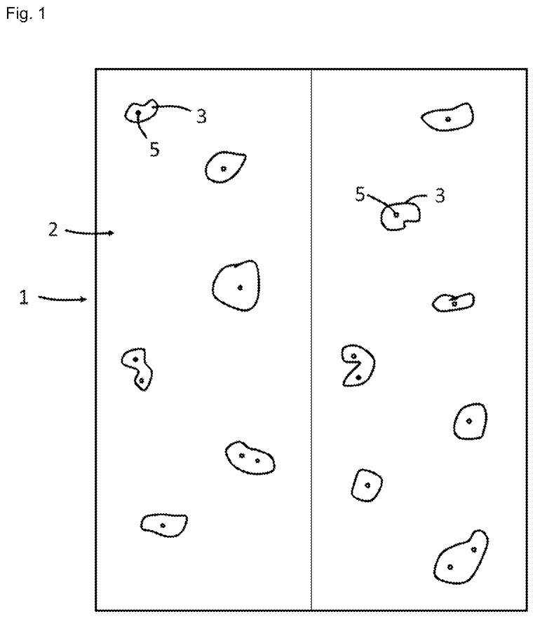

FIG. 1 is a schematic representation of an artificial climbing structure in accordance with one embodiment of the invention.

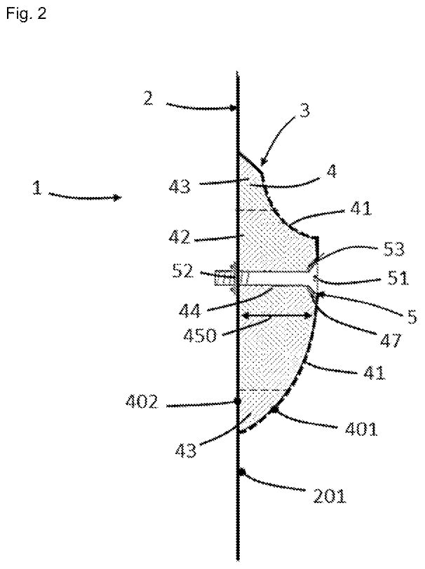

FIG. 2 is a schematic view in section of an example of a hold in accordance with a first embodiment.

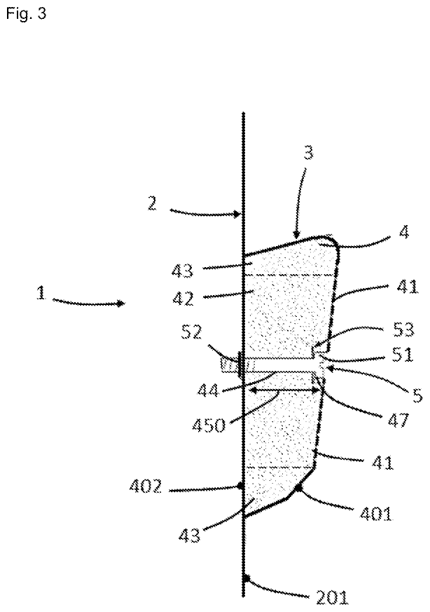

FIG. 3 is a schematic view in section of a second example of a hold in accordance with a first embodiment.

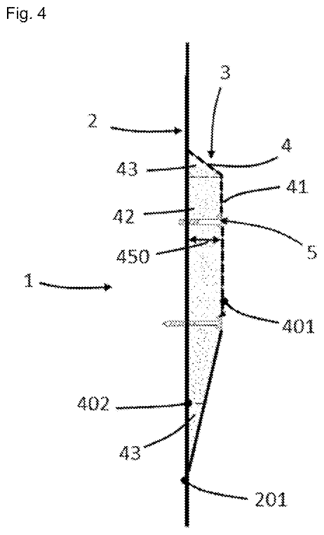

FIG. 4 is a schematic view in section of a third example of a hold in accordance with a first embodiment.

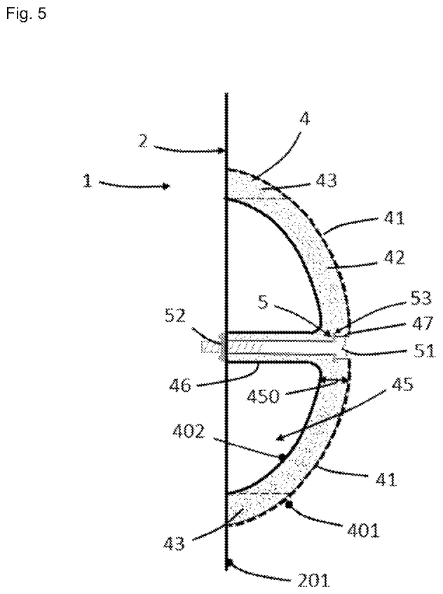

FIG. 5 is a schematic view in section of an example of a hold in accordance with a second embodiment.

FIG. 1 schematically depicts one embodiment of an artificial climbing structure 1. The structure 1 includes one or more walls 2, for example made of wood or engineered wood, rock, brick, concrete, metal and/or a synthetic material, for example a thermoset resin, thermoplastic resin or elastomer resin, with or without additives and/or adjuvants. The structure 1 may have a varying inclination, for example up to 90° relative to a vertical direction. The structure 1 further includes at least one removable climbing hold 3 mounted on and fixed to said wall 2. The structure 1 preferably includes a plurality of holds 3, in particular arranged to define routes of varying difficulty.

FIGS. 2 to 5 depict different alternative embodiments of a removable climbing hold 3 in accordance with the invention.

Generally speaking, the climbing hold 3 in accordance with the invention comprises a body 4 made of a composition including at least one thermoplastic material. By “thermoplastic” material is meant a plastic material which, heated to a predetermined temperature, is malleable and can be injected into a mold having the appropriate shape, and, when cooled, becomes solid so as to have the structural aspect of the injection molded part. Furthermore, the present invention may be applied to a body 4 the composition of which includes a plurality of thermoplastic materials having, for example, different mechanical characteristics, in particular stiffness characteristics. In particular, the composition may include at least 50% of at least one thermoplastic material or of a mixture of thermoplastic materials.

Depending on the type of hold 3 required, the body 4 may be various shapes. It has in particular a first surface 401 configured to be in contact with a limb of a user, for example a hand, one or more fingers, or even a foot, and a second surface 402, opposite the first surface 401 and configured to come at least partly in contact, in particular in bearing engagement, with the wall 2 of the artificial structure 1. In other words, the second surface 402 is not visible to a user. In particular, all or part of the first surface 401 may include one or more grained zones, described in more detail hereinafter, so as to confer on the body 4 adhesion properties suitable for climbing. Additionally or alternatively the first surface 401 may include one or more smooth or substantially smooth surfaces.

The at least one thermoplastic material may be a thermoplastic elastomer material (TPE). In particular, the at least one thermoplastic material may be selected from thermoplastic polyurethanes (TPU), copolyester elastomer thermoplastics, also known as thermoplastic copolyesters (TPC) or copolyester elastomer (COPE), polyamide thermoplastic elastomers, styrene-based thermoplastic elastomers, thermoplastic polyolefins, polyacrylics, polycarbonates (PC), polyphenylene sulfide (PPS) and/or polymethacrylates (PMMA).

Polyamide thermoplastic elastomers, for example thermoplastic ether-amide bloc copolymers (TPA) or thermoplastic elastomers based on polyether block amides (PEBA), have in particular good resistance to abrasion and to UV. Furthermore, they are conventionally lighter than polyurethane thermoplastics or copolyester elastomer thermoplastics.

Styrene-based thermoplastic elastomers (TPS) may for example be styrene-butadiene-styrene block copolymers (SBBS) or styrene-ethylene-propylene-styrene block copolymers (SEBS), known to have good resistance to bending and to repeated impacts as well as to abrasion.

The polyamide thermoplastic elastomers may be PA11 or PA12, having good flexibility and impact resistance. By way of non-limiting example, PA11 can be obtained from castor oil.

The thermoplastic polyolefins (TPO) may be a thermoplastic elastomer based on vulcanized thermoplastics (TPV), polypropylene (PP) or polyethylene (PE).

The at least one thermoplastic material is advantageously recyclable. “Recyclable” means that the body 4 of the climbing hold 3, when worn or damaged, can be heated again to form, as described above, a malleable compound that can be used again for conventional methods of shaping thermoplastics or in the method of manufacturing a climbing hold 3 in accordance with the invention. In particular, the at least one thermoplastic material may be of noble base, partly or entirely recycled and/or obtained from thermoplastic material of vegetable origin. For example, some of the thermoplastic material may be industrially shredded, that is to say a mixture of thermoplastic materials the composition and the exact proportions of which are not defined but which can, for example, include one or more of the thermoplastic materials cited above.

The body 4 of the hold 3 is thus obtained by transformation of the at least one thermoplastic material. In particular, the body 4 of the hold 3 may be obtained by the transformation of the at least one thermoplastic material when foamed, as explained further hereinafter with reference to the method of manufacturing the climbing hold 3 in accordance with the invention. For example, when the thermoplastic material has cooled the foam of the at least one thermoplastic material concerned may have a specific gravity between 0.2 and 2, in other words a density between 200 and 2000 kg/m3, or even between 0.3 and 1.7, that is to say between 300 and 1700 kg/m3.

In order to have appropriate resistance to manipulation and repeated impacts, the body 4 of the hold 3, in particular by virtue of its composition, preferably has a hardness greater than 55 ShD, in particular greater than 70 ShD and up to 100 ShD. For example, the body 4 may have a hardness of the order of 80 ShD.

Such a hardness can be provided by the at least one thermoplastic material chosen, a combination of thermoplastic materials, or, alternatively, the composition may include a charge in order to achieve the required hardness.

Thus the composition of the body 4 may optionally include at least one charge, also known as an “additive”, in particular a recyclable charge. Thus the composition may include 0 to 30% of the at least one charge or of a mixture of charges. When the composition includes at least one charge it includes in particular from 1 to 20% of the at least one charge or of a mixture of charges.

The at least one charge may in particular be incorporated in the composition of the body 4 during a compounding operation carried out before shaping the part, for example by a supplier of the at least one thermoplastic material. Alternatively, the at least one charge may be incorporated during manufacture of the part, in particular during the method of manufacture in accordance with the invention.

The at least one charge may be selected from calcium carbonate, talc, mica, glass, a natural mineral charge and/or a natural vegetable charge. In particular the composition of the body 4 of the hold 3 may include a mixture of a plurality of charges selected from the aforementioned charges. In a non-limiting manner, depending on the type of charge used, the latter may take the form of a powder or of fibers.

Adding at least one charge to the composition of the body 4 of the hold 3 contributes in particular to improving the properties of the latter. Adding such a charge furthermore enables reduction of the mass of the hold 3 as well as its production cost by the reduction of the quantity of thermoplastic material used. Furthermore, the at least one charge may have a nucleating agent function so that it reacts with the at least one thermoplastic material in order to facilitate the transformation thereof, in particular by reducing the cycle time, and/or to improve the technical properties of the body.

For example, adding at least one charge such as calcium carbonate or talc advantageously further makes it possible to improve the surface state of the part obtained and can contribute to obtaining at least one grained zone.

A charge based on mica, in particular on aluminum silicate, may take the form of a film, a powder or flakes. In addition to increasing the rigidity of the body 4 of the hold 3, such a charge advantageously confers additional protection against UV on the body 4 of the hold 3.

A charge based on glass may take the form of fibers or small solid or hollow balls. For example, such balls may have a diameter of the order of 10 to 120 μm. Glass in particular makes it possible to improve the thermal and mechanical properties of the body 4.

The natural mineral charge may be a charge obtained from byproducts. It may in particular include, by way of non-limiting example, a mineral-based powder or fibers obtained from shells, in particular shells of crustaceans such as oysters, scallops or mussels.

Similarly, the natural vegetable charge may take the form of a powder or fibers obtained from nuts, pips, husks of cereals such as rice, wheat or rye, oleaginous or other shells. It can equally take the form of natural fibers of wood, flax, hemp, bamboo, etc.

Using charges of mineral or vegetable natural origin in particular has an environmental benefit. It can in particular allow the incorporation and the recycling of otherwise unused agricultural waste and may be a lighter alternative to the use of glass, for example. Also, the various types of charge referred to above have the advantage of being recyclable but also of being available at low cost.

Furthermore, the composition used for the production of the body 4 of the hold 3 may optionally include, in combination with or instead of the at least one charge, at least one adjuvant. The composition may include from 0 to 15%, or even 1 to 10%, of the at least one adjuvant or of a mixture of adjuvants. The at least one adjuvant may be selected from a coloring agent or pigment, a plasticizing agent, a swelling agent, also known as an expansion agent, and/or an anti-UV agent, which is to say that it may have one or more of said functions. The composition may also include a combination of a plurality of adjuvants, with similar or distinct functions.

For example, the at least one swelling agent, like the at least one charge, contributes to reducing or even preventing shrinkage of the at least one thermoplastic material in the mold during the manufacture of the climbing hold 3. The swelling agent participates in particular in obtaining a foam texture of the at least one thermoplastic material to be injected and can 30) therefore contribute to obtaining the at least one grained zone at the level of the first surface 401 of the body 4. The use of a swelling agent in particular makes it possible to optimize the reproduction in negative form of a grained portion in the mold in order to obtain the at least one grained zone in the body.

The at least one swelling agent may be selected from agents enabling chemical expansion, that is to say that enable swelling of the composition by chemical reaction because of the effect of temperature that leads to the formation of gas. Such chemical expansion is in particular carried out before the introduction of the composition into a mold in order to produce the hold in accordance with the invention, for example in a plasticization unit as described hereinafter with reference to the method of manufacture in accordance with the invention. In particular, the at least one swelling agent may be selected from citric acid and/or sodium bicarbonate, enabling an endothermic reaction, or from an azodicarbonamide (ADC), an oxy-bisbenzenesulfonylhydrazide (OBSH) and/or a toluenesulfonylhydrazide (TSH), enabling an exothermic reaction.

Alternatively or additionally the at least one swelling agent concerned may be water, or in other words the moisture content of the composition used for the production of the body 4. Such moisture content is in particular measured before the introduction of the composition into the mold, for example before execution of the method of manufacture in accordance with the invention, or at the level of the granular thermoplastic material by means of a hydrometric probe. In fact, water, for example in amounts between 0.02 and 5% by weight inclusive, for example between 1 et 4% inclusive, can function as a chemical expansion agent for some thermoplastic materials.

Note that, when other swelling agents are used in the composition, the latter, in particular the at least one thermoplastic material, may optionally be baked and/or desiccated in order to eliminate all traces of moisture.

The at least one swelling agent may also be, as an alternative to or in combination with the aforementioned swelling agents, nitrogen or carbon dioxide, for example so as to enable physical expansion of the composition, in particular during a step of:
injecting carbon dioxide or nitrogen in the supercritical state, for example at the level of an injection screw, so as to enable mechanical foaming of at least one thermoplastic material, or
pre-conditioning the at least one thermoplastic material with carbon dioxide under pressure.

According to a further example, which may be employed instead of or in combination with the foregoing examples, the at least one swelling agent may be selected from plastic microspheres containing at least one gas, for example carbon dioxide, isobutane, isooctane, isopentane and/or pentane. Such microspheres enable physical expansion of the composition. These microspheres are introduced into the composition, for example at the level of the plasticization unit, and, because of the effect of heat, the gas contained in the microspheres expands. Such expansion continues in the mold, in particular in contact with the thermoplastic material, until it leads to bursting of the microspheres, thereby creating porosities in the body 4 of the hold. In expanding in the at least one thermoplastic material the gas therefore enables expansion thereof. This technique in particular enables good homogeneity of the bubbles formed and therefore better homogeneity on the scale of the body 4. The use of heavy gases advantageously makes it possible to prevent a plurality of porosities merging, such merging possibly leading to the formation of cavities liable to weaken the body 4 of the hold. Furthermore, the negligible quantities of plastic material used for the production of the microspheres does not affect the recyclability of the hold.

Depending on the foaming process and the composition employed, the foams obtained may, once cooled, have a varying porosity, the pores obtained in this way contributing to the definition of the surface grain of the holds 3, in particular at the level of the grained zone 41. For example, the body 4 may have a porosity between 0.002 mm³ and 0.4 mm³ inclusive.

Accordingly, in a more generic manner, the composition of the body 4 may consist of:
at least 70% of the at least one thermoplastic material or of a mixture of a plurality of thermoplastic materials, in particular as described above,
between 0 and 15%, or even 1 and 10%, of the at least one swelling agent, or of a plurality of swelling agents,
and/or 0 to 20%, of even 1 to 17%, of the at least one charge.

FIGS. 2 to 5 depict different embodiments of the hold 3 in accordance with the invention mounted on an artificial structure wall 2. All or part of the first surface 401 may advantageously include at least one grained zone 41 produced in one piece with the body 4 and at least essentially obtained from the at least one thermoplastic material. In particular, the hold may include a single grained zone 41 or a plurality of grained zones 41. By “grained” zone is meant a zone of the first surface 401 having a rough appearance that can be discerned by touch by the user and visible to the naked eye, conferring on the hold 3 adhesion qualities necessary for climbing. In particular, it may be defined by a grain between 0.1 and 2 mm inclusive, or even between 0.1 and 1 mm inclusive. By “essentially” is meant that at least 50% of the surface of the grained zone 41 concerned is obtained from the at least one thermoplastic material.

Also, such graining may be irregular and/or regular. Furthermore, the first surface 401 may include a plurality of grained zones distinct from one another and able to have, from one zone to another, one or more grains with similar or different dimensions.

Such a grained zone 41 is in particular produced in one piece with the body 4, that is to say does not consist of a layer applied to the body. The grained zone 41 is also essentially obtained from the transformation of the at least one thermoplastic material, that is to say from at least 50% of the transformation of the at least one thermoplastic material or of a mixture of thermoplastic materials included in the composition of the body 4. In other words, such a grained zone 41 is to be distinguished from the use of coatings conventionally applied to thermoplastic materials or to climbing holds 3, for example made of wood. The grained zone 41 can therefore be the result of the composition of the body as described above, in particular the use of at least one swelling agent that induces a porosity of the body and/or the use of at least one charge.

Additionally or alternatively, the grained zone may be obtained negatively by means of a mold including at least one grained portion that is configured to enable the climbing hold 3 in accordance with the invention to be obtained, as explained further hereinafter. The use of at least one swelling agent advantageously enables improved negative retranscription of the mold intended to form the grained zone, in particular by fluidizing the composition so that it espouses even the least asperity of the mold. The result of this is elimination of the necessity for mechanical and/or chemical surface treatment steps and application of one or more coating layers conventionally enabling the grained appearance required of climbing holds to be obtained.

The parts made of thermoplastic materials, because of the methods of manufacture employed, conventionally have a small thickness, in particular a mean thickness of the order of 1.5 to 3.5 mm, or even less than or equal to 1 mm. The parts obtained in this way are nevertheless more fragile and unsuitable for the application of repeated and high forces, with the risk of being deformed or even broken. Moreover, it is technically more complicated to obtain homogeneous mechanical properties at the scale of the part, which greatly influences the cost of the tooling. In this sense the application of such methods is typically set aside for the manufacture of climbing holds 3, the use of non-recyclable thermoset materials then being preferred.

In order to alleviate such disadvantages and to propose a recyclable hold 3 having rigidity or stiffness characteristics suitable for climbing, the shape of the body 4 of the hold 3 in accordance with the invention is also optimized in order to suit the composition of the body.

Generally speaking the body 4 of the hold 3 includes a central zone 42 surrounded by edges 43 that delimit the shape of the body. Furthermore, the hold 3 may include at least one through-opening 44 and at least one fixing means 5. The opening 44 extends through a thickness 450 of the body 4 measured between the first surface 401 and the second surface 402 and is configured to receive the fixing means 5. In particular, the hold 3 may include a plurality of openings 44 in order to enable fixing of the hold 3 with a plurality of fixing means 5 at distinct points.

In an optional but preferred manner the opening 44 is disposed in the central zone 42 of the hold 3, that is to say at a distance from the edges 43. The edges may, by way of non-limiting example, be defined as a cordon of the order of 1 to 2 cm bordering a contour of the body of the hold 3. The body 4 may in particular have variations of thickness 450 depending on whether the latter is measured at the level of the central zone 42 or at the level of the edges 43. For example, the hold has a smaller thickness 450 at the level of the edges 43 than at the level of the central zone 42. The same applies when the hold 3 includes a plurality of openings 44.

Furthermore, in order to confer appropriate strength on the body 4 the thickness 450 of the body is defined as a function of the shape thereof but also of its composition.

In accordance with a first embodiment depicted in FIGS. 2 to 4 the body 4 may have a solid monobloc shape. In other words, the body 4 has a filled-in profile, in contrast to the hollow shapes conventionally seen in parts resulting from the transformation of thermoplastic materials. In such an embodiment most of the body 4 has a thickness 450 greater than or equal to 5 mm, in particular greater than or equal to 8 mm, or even 10 mm. By “essentially” is meant that at least 50% of the body 4, for example 50% of the visible surface of the body 4, namely here of the first surface 401.

For example, the thickness of the hold may be between 5 and 100 mm inclusive. In particular, at least 70%, or even 85%, of the body can have such a thickness. In accordance with one particular embodiment at least the central zone 42 has a thickness 450 defined according to such dimensions. In other words, at least the whole of the body 4 with the exception of the edges 43, that is to say its peripheral zone, has such a thickness. The extreme edges can then have a thickness 450 less than 5 mm. Alternatively, the body 4 has a thickness 450 defined according to such dimensions in the region of the opening or openings 44 adapted to receive a means 4 for fixing the hold 3.

The second surface 402 may preferably be plane or substantially plane in order to optimize the contact thereof with the wall 2 of the artificial structure 1. The second surface thus extends at most as far as possible in contact with the wall 2 when the hold is mounted on the latter. The through-opening 44 extends from the first surface 401 as far as the second surface 402 opposite the first surface 401 and opens directly onto the wall 2 when the hold 3 is installed. In accordance with an alternative that is not represented the second surface 402 may be irregular.

As explained above, the body 4 may have an irregular shape, in particular an irregular thickness 450.

In accordance with a second embodiment depicted in FIG. 5 the body 4 may have a hollow monobloc shape. In other words, the body 4 is hollow and takes the form of a shell so that, when the hold 3 is mounted on the wall 2, some or all of the edges 43 bear on the wall 2 while the central zone 42 extends at a non-zero distance from the latter, thus delimiting with the wall 2 a void 45.

In such an embodiment most of the body 4 has a thickness 450 greater than or equal to 8 mm, or even 10 mm. As explained above, by “essentially” is meant at least 50% of the body 4, for example 50% of the visible surface of the body 4, in this instance of the first surface 401. In particular, at least 70%, or even 85%, of the body may have such a thickness. For example the thickness 450 of the body 4 may be between 12 and 100 mm inclusive, or even between 20 and 60 mm inclusive or again between 20 and 45 mm inclusive. The thickness 450 of the body is then measured between the first surface 401 at a distance from the wall 2 and the second surface 402 facing toward the same wall 2 and delimiting the void 45. In a similar way to what has been explained above, such a thickness contributes to obtaining a stiffness suited to repeated forces. In a similar way to what has been explained above, in particular at least the central zone 42 has a thickness 450 defined according to such dimensions. In other words, at least all of the body 4 with the exception of the edges 43, that is to say of its peripheral zone, has such a thickness. The edges may then have a thickness 450 less than 8 mm. As a further alternative, the body 4 has a thickness 450 defined according to such dimensions in the region of the opening or openings 44 adapted to receive a means 4 for fixing the hold 3.

The opening or openings 44 thus extend(s) through the thickness 450 of the body 4 and open(s) into the void 45. Optionally, but preferably, the body 4 may include a guide and/or reinforcing member 46. Such a member 46 may have a continuous or non-continuous shape. Also, such a member may be cylindrical or inscribed within a substantially cylindrical shape. The member 46 surrounds the opening 44 and extends in continuity therewith so that it is able to receive the fixing means 5. The member 46 can then be centered on an axis passing through the opening 44, for example. The member 46 then advantageously enables guidance of the fixing means 5 in an appropriate direction so as to facilitate the fixing of the climbing hold 3 onto the wall 2. Such a member 46 may optionally be sized so as to come to extend in bearing engagement with the wall 2 of the climbing structure 1 when the hold 3 is installed in the latter, thus conferring upon it a function of reinforcing the body 4. In other words, the guide and/or reinforcing member 46 can then extend between the second surface 402 of the body 4 and a bearing plane of the body 4 in which are inscribed some or all of the edges 43 of the body 4.

Thus, in a more generic manner, the body 4 may have a solid or hollow structure most of which, even 70% or again 85%, has a thickness 450 greater than or equal to 8 mm, or even 10 mm, such a measurement being in particular produced at the level of the central zone 42 of the body 4 or in the region of one or more openings 44 in the body 4.

Independently of the embodiment of the body 4 used, the hold 3 may be fixed onto the wall 2 of the artificial structure 1 in accordance with various alternatives. As explained above, the climbing hold 3 may be removably mounted on and fixed to the wall 2 of the artificial climbing structure 1 by means of at least one fixing means 5 passing through the hold 3 at the level of the opening 44 in the body 4.

The hold 3 is disposed on the wall 2 so as to be in at least partial contact with a first face 201, corresponding in particular to a face visible to a user, of the wall 2 of the artificial structure 1. Some or all of the edges 43 and/or of the second surface 402 of the body 4 may then extend bearing on the first face 201 of the wall 2.

FIGS. 2 to 5 depict various non-limiting examples of fixing means that can be used with a removable climbing hold 3 in accordance with the invention. The fixing means 5 may include at least one first fixing element 51. By way of non-limiting example, the first fixing element 51 may be a bolt, in particular of the M10 CHC or FHC socket-head screw type, as depicted in FIGS. 2, 3 and 5, or a screw, for example a woodscrew, as represented in FIG. 4.

The fixing means 5 may optionally include a second fixing element 52 complementary to the first fixing element 51. In particular, the second fixing element 52 may be a metal or plastic insert mounted in a hole in the wall 2. The second fixing element 52 may then, for example, be clipped, glued, stamped, screwed or force-fitted so as to be disposed in the wall 2 or, alternatively, on the wall 2 at the level of a second face of the wall 2 opposite the first face 201. The first fixing element 51 therefore extends through the hold 3 and the hole in the wall 2 in order to cooperate with the second fixing element 52.

The fixing means 5 may optionally further include a washer 53, for example a flat washer 53 or a conical washer 53, and/or a biasing element, such as a spring, and/or any element for absorbing stress such as a flat wire, configured to be disposed between the hold 3 and at least a part of the first fixing element 51, for example a head of a bolt. In this sense the body 4 of the climbing hold 3 may advantageously include a reinforcement 47, in particular incorporated in the first surface 401, configured to receive said washer 53 and the head of the first fixing element 51, thus preventing contact of a user with the fixing means 5.

It is to be understood that the features relating to the fixing means 5 extend to a climbing hold 3 fixed to the wall 2 by means of a plurality of fixing means 5, as depicted in FIG. 4. The fixing means used for fixing the holds 3 concerned may then be similar or have different features.

The invention finally concerns a method of manufacturing a climbing hold 3 in accordance with the invention based on a composition as explained above. In fact, as explained in detail above the features relating to said hold 3, in particular the use of at least one thermoplastic material, the presence of at least one grained surface, the stiffness or the thickness 450 of the body 4, render the standard methods of molding thermoplastic parts inappropriate.

In fact, such methods are conventionally executed by injection of the poured viscous plastic material into a mold defining an imprint of the required part. In the case of methods of injection assisted by a fluid, for example by a gas or by a liquid, a feed unit injects, or pours, the thermoplastic material in a first step and then, in a second step, injects said fluid under pressure into the thermoplastic material so as to push it into the imprint. The pressures employed are usually described as “high pressures”, that is to say pressures greater than 500 bar, for example of the order of 500 to 2500 bar. The thermoplastic material is then pressed against the walls 2 of the imprint so as to form a thin hollow part, for example much less than 5 mm thick or of the order of 1 to 4 mm thick, the high pressures exerted enabling limitation of the shrinkage of the material as it cools. Similarly, in the case of injection methods not assisted by a fluid the thermoplastic material is injected into the mold at high pressure, in particular at the end of filling, in order to limit shrinkage of the material during cooling of the part.

Such methods are unsuitable for producing parts made of thermoplastic material(s) of great thickness, that is to say of thickness greater than or equal to 10 mm. In fact, the parts obtained then have non-negligible surface defects, in particular because of the cooling of the material in contact with walls of the imprint not occurring at the same rates as the rest of the part, in particular at its center. This temperature difference and the thermal properties of thermoplastic materials lead to shrinkage taking the form of wavelets, also known as shrink marks.

Such an effect may be accentuated by the use of molds made of rigid materials, in particular metals such as steel or aluminum. The use of rigid molds is classically imposed by injection of fluid and/or of a thermoplastic material and/or of resins at high pressure, failing which the mold could be damaged, for example torn. Such molds nevertheless have the disadvantage of being costly, thus rendering them inappropriate for the production of climbing holds 3, generally produced in short runs.

The method in accordance with the invention aims to resolve the aforementioned disadvantages. Generally speaking, it includes a step of injection, extrusion or co-extrusion of the composition including the at least one thermoplastic material. In particular, a plurality of steps may be executed, for example combining injection and then intrusion. The at least one thermoplastic material in the solid state, for example in granular form, evolves through a plasticization unit. By way of non-limiting example the plasticization unit may include a lead screw rotatable by a motor, in particular a servomotor. The screw is disposed in a heating cylinder into which the composition, in particular the at least one thermoplastic material when solid, is fed. The at least one thermoplastic material is heated, melted and mixed in the cylinder and then fed to the imprint of the mold.

The at least one thermoplastic material melted in this way is preferably foamed, for example using at least one swelling agent and/or by means of one of the methods explained above. Such methods may also necessitate or not the addition of nucleating agents, in particular one or more of the charges referred to above, which can be used to reduce the cycle time and/or to improve the technical properties of the finished product.

For example, of the examples and methods cited, injection of carbon dioxide or of nitrogen in the supercritical state on the one hand or physical expansion by microspheres on the other hand enables the production of regular and homogeneous gas microbubbles in the composition including the at least one thermoplastic material. Conversely, methods using exothermic or endothermic chemical swelling agents produce bubbles of varying size that merge with one another to form cavities with greater dimensions. Cooling of the material must then be tightly controlled, cooling that is too slow being characterized in fact by excessive merging of these cavities leading to a severe reduction of the strength of the body 4. In order to limit or even to prevent such an effect, one or more charges as explained above may be added to the composition. In particular, talc may be selected for its nucleating agent function, this function limiting the merging of the bubbles so as to preserve mechanical properties of the body 4 suitable for climbing.

The composition may be injected into the mold continuously or, alternatively, the quantity of material necessary for producing a hold 3 may be injected all at once into the imprint of the mold.

The injection or coextrusion step is carried out at low pressure, in particular at a pressure between 0 and 200 bar inclusive, in particular between 0 and 75 bar inclusive, or even between 0 and 50 bar inclusive, in a flexible mold, that is to say a mold having elastic properties. In particular cases the injection or coextrusion step may be carried out at a pressure between 0 and 15 bar inclusive. By way of non-limiting example, when an injection step is used the pressure may of the order of 1 to 10 bar whereas when a coextrusion step is used the pressure may be of the order of 0 bar.

The mold may in particular be made of an elastomer silicone or rubber. The mold may in particular include at least one grained portion the negative of which forms in the first surface 401 of the climbing hold 3 obtained as the method proceeds at least one grained zone 41 as explained above. The mold may in particular be held by a rigid mold support or imprint support made for example of metal, resin or wood, while the assembly formed by the mold support and the mold is closed by a counter-mold. The mold holder and the counter-mold therefore limit the deformation of the flexible mold and the assembly formed by the mold and the counter-mold defines the imprint of the climbing hold 3, in particular of the body 4. A closure system enables actuation, movement and retention of the counter-mold. The injection nozzle, in other words a point of injection of the composition, is preferably arranged at the level of the counter-mold.

The mold may optionally be arranged in a heated enclosure, or an oven, so as to preheat the mold before injecting the composition and thus to limit or to prevent thermal shock in contact with the mold. For example, the temperature in such an enclosure may be between 1° and 100° C., inclusive, in particular close to 50° C., so that, during filling, the mold is at a temperature between 2° and 100° C. inclusive.

The hold 3 obtained in this way is then cooled. The hold 3 may be cooled before and/or after extraction of the part from the mold, for example by means of a stream of gaseous or liquid fluid, in order to lower its temperature to around 70° C. For example, cooling executed before extraction from the mold may be effected by means of a flow of water, oil or air. Cooling effected subsequently to extraction from the mold could, in a non-limiting manner, be effected by means of a flow of air or of water. The body 4 obtained in this way does not need further mechanical or chemical surface treatment and is advantageously recyclable.

Thus the present invention proposes a recyclable climbing hold having mechanical properties, in particular of stiffness and of adhesion, suitable for climbing. The composition of the hold and its shape contribute to providing its high strength and enable the production of holds the body of which may be monobloc, of varying shape and/or thickness, and in particular include one or more grained surfaces. This invention also proposes a method of manufacturing such a part.

However, the present invention should not be limited to the means and configurations described and depicted here and extends equally to any equivalent means or configuration and to any technically operative combination of such means to the extent that in fine they provide the functionalities described and depicted in the present document.

1. A removable climbing hold for an artificial climbing structure,
wherein the removable climbing hold comprises a body,
wherein the body is made from a composition including at least one thermoplastic material.

2. The climbing hold as claimed in claim 1, wherein at least 50% of the body has a thickness greater than or equal to 8 mm.

3. The climbing hold as claimed in claim 1, wherein the body has a solid monobloc shape and at least 50% of the body has a thickness greater than or equal to 5 mm.

4. The climbing hold as claimed in claim 1, wherein the body has a hollow monobloc shape.

5. The climbing hold as claimed in claim 1, wherein at least a portion of a first surface of the body is configured to be in contact with a limb of a user and has at least one grained zone, at least 50% of a surface of the at least one grained zone being made from the at least one thermoplastic material.

6. The climbing hold as claimed in claim 1, wherein the at least one thermoplastic material is selected from the group consisting of thermoplastic polyurethanes, copolyester thermoplastic elastomers, polyamide thermoplastic elastomers, styrene-based thermoplastic elastomers, thermoplastic polyolefins, polyacrylics, polycarbonates, polyphenylene sulfide, and polymethacrylates.

7. The climbing hold as claimed in claim 1, wherein the composition includes at least one charge and/or at least one adjuvant selected from the group consisting of coloring agents, pigments, plasticizing agents, swelling agents, and anti-UV agents.

8. The climbing hold as claimed in claim 7, wherein the composition includes:
at least 50% of at least one thermoplastic material or a mixture of thermoplastic materials, and/or
0 to 15% of the at least one adjuvant, and/or
0 to 30% of the at least one charge.

9. The climbing hold as claimed in claim 1, wherein the at least one adjuvant is a swelling agent selected from the group consisting of citric acid, sodium bicarbonate, azodicarbonamides, oxy-bis benzenesulfonyl hydrazides (OBSH), toluenesulfonylhydrazide (TSH), water, and plastic microspheres containing a gas.

10. An artificial climbing structure including at least one wall and at least one climbing hold as claimed in claim 1, mounted on and fixed to the wall.

11. A method of manufacturing a climbing hold, the method comprising:
injecting, intruding and/or coextruding the composition including the at least one thermoplastic material at low pressure, into a flexible mold,
so as to obtain the climbing hold as claimed in claim 1.

12. The method as claimed in claim 11, wherein the low pressure is in a range of from 0 to 200 bar inclusive.

13. The method as claimed in claim 12, wherein the low pressure is in a range of from 0 to 75 bar inclusive.

14. The method as claimed in claim 13, wherein the low pressure is in a range of from 0 to 50 bar inclusive.

15. The method as claimed in claim 11, wherein the flexible mold is made of an elastomer material or rubber.

16. The climbing hold as claimed in claim 1, wherein most of the body has a thickness greater than or equal to 10 mm.

17. The climbing hold as claimed in claim 1, wherein the body has a solid monobloc shape and most of the body has a thickness greater than or equal to 8 mm.

18. The climbing hold as claimed in claim 1, wherein the body has a solid monobloc shape and most of the body has a thickness greater than or equal to 10 mm.

19. The climbing hold as claimed in claim 8, wherein the composition includes:
0 to 10% of the at least one adjuvant, and/or
0 to 20% of the at least one charge.

20. The climbing hold as claimed in claim 9, wherein the at least one adjuvant is plastic microspheres containing a gas selected from the group consisting of carbon dioxide, isobutane, isooctane, isopentane, and pentane.
